(19) United States
(12) Patent Application Publication
(10) Pub. No.: US 2004/0117997 A1
(43) Pub. Date: Jun. 24, 2004

(54) JAK measuring system and method of use

(76) Inventor: John Anthony Karageorge, Ocean City, MD (US)

Correspondence Address: JOHN A. KARAGEORGE, 14137 SEA CAPTAIN RD., OCEAN CITY, MD, 21842, US

(21) Appl. No.: 10/695,612

(22) Filed: Oct. 29, 2003

Related U.S. Application Data
(63) Continuation-in-part of application No. 09/986,565, filed on Nov. 9, 2001, now abandoned.

(51) Int. Cl. G01C 3/04

(52) U.S. Cl. 33/494

(57) ABSTRACT

An improved measuring system that aligns with the decimal system and the speed of light, and yields user friendly results when converting between U.S. linear, metric, and the speed-of-light measuring systems. It is an intelligent system, one that society will easily learn and embrace.

### CROSS-REFERENCE TO RELATED APPLICATIONS

This application is a Continuation-In-Part of Ser. No. 09/986,565 filed on Nov. 9, 2001.

### BACKGROUND OF THE INVENTION

1. Technical Field of the Invention

This invention is a measuring system that recalibrates and renames the U.S. linear and metric systems so that conversions between them are user friendly. It also goes a step further and aligns them both with another system, the light-unit (light-year) measuring system thereby making conversions between all three systems easier for everyone from students in school to our top leading scientists.

2. Prior Art

Today there are several measuring systems used around the globe. In the United States we use three systems: the U.S. Customary System, the International System of Units (known as SI for Systeme International (this is a more complete version of the metric system)), and the speed-of-light (distance per time) measuring system (light-year, light-second, etc.).

The U.S. Customary System is an offshoot of the British Imperial System which has been slightly altered over the years. The base unit of the U.S. linear system is the foot which is subdivided into twelve equal segments called inches. Three feet make a yard, and 5,280 feet equal one mile.

The base unit of the metric-linear system is the meter. Since its conception, the length of the meter has been defined and redefined several times in an attempt to identify it as a dependable source of universal standard reference for linear measuring. Today the meter is the basic measurement of length in physics. The meter has been defined as the distance between two fine lines on a bar of platinum-iridium alloy. In 1960, the meter was redefined as 1,650,763.73 wavelengths of the reddish-orange light emitted by the isotope krypton-86. And finally, in 1983, after the speed of light had been accurately measured and verified, the meter was redefined as the length of the path traveled by light in a vacuum during a time interval of 1/299,792,458 of a second.

The meter is subdivided into smaller units: 1,000 millimeters=one meter, 100 centimeters=one meter, and 10 decimeters=one meter. One thousand meters equal one kilometer. There are 25.4 millimeters per inch, and one centimeter is equal to 0.3937007874015748031496062992126 inches. There are 30.48 centimeters per foot, 91.44 centimeters per yard, and 39.37007874 inches per meter. There are 3,280.8398950131233595800524934383 feet per kilometer, and 1,609.344 meters per mile.

There are 1.609344 kilometers per mile; this equates to 0.62137119223733396961743418436332 miles per kilometer (1/1.609344=0.62137119223733396961743418436332). Since the U.S. linear system is not aligned with the decimal system (10 inches to the foot, etc.) nor with the metric system, conversions between the U.S. linear system and the metric linear system are cumbersome.

The speed-of-light measuring unit (the light-year) was developed to aid in the measuring of astronomical distances for interstellar astronomy. It is a complex system that uses the rate of speed of light in conjunction with a period of time to specifically determine very large distances. It was not intended for minute precision (a fraction of an inch, etc.) nor for everyday use by the average person or builder. The speed of light has been defined as 299,792.458 kilometers per second (186,282.3970512208701185079137835 miles per second) in a vacuum by the International Astronomical Union System of Astronomical Constants since 1976.

The velocity of light is not constant across all mediums. The speed of light in glass is approximately 33% slower than when in a vacuum, 25% slower in water than when in a vacuum, and about 3% slower going through air as opposed to traveling in a vacuum.

Since the ratio between the U.S. linear system and the metric linear system is 1.609344 to 1, and the ratio between these systems and the speed-of-light measuring unit (the light-year) is not uniform, conversion calculations can tend to be awkward and error prone requiring one to always check their figures for accuracy, even in the simplest of calculations. The present invention with its uniformity of alignment alleviates this necessity.

### SUMMARY

The present invention is directed to linear measurement systems only. The primary difference distinguishing this invention from most if not all other measuring inventions is the prior art uses the same size inch, foot, mile, centimeter, kilometer, etc. The present invention recalibrates the aforementioned and aligns them so that conversions between the U.S. linear system and the metric system are easier to relate to and deal with (10 JAK-inches to the JAK-foot, 5,000 JAK-feet to the JAK-mile, 1.5 JAK-kilometers per JAK-mile, etc.). (Hereinafter, measurement increments of the present invention will be classified with the prefix “JAK”.) The present invention goes a step further and also aligns them so that conversions between the present invention and the light-unit measuring system are user friendly (200,000 JAK-miles per one light-second, 300,000 JAK-kilometers per one light-second). This makes conversions between all three systems easier for everyone from students in school to our top leading scientist.

A physical copy of the present invention can be arranged with other measuring systems on a device such as a multiple scale ruler for the purpose of manufacture as is revealed in the U.S. Pat. No. 1,497,492 issued Jun. 10, 1924, to H. W. Engel.

It is the principal object of the present invention to provide an improved, user friendly measuring system for everyday use.

Another object of the present invention is to provide a recalibrated measuring system where the alignment between the JAK-linear system and the JAK-metric linear system yield conversions that are easier to relate to and deal with.

Yet another object of the present invention is to provide a recalibrated measuring system where the alignment between both the JAK-linear system and the JAK-metric linear system yield user friendly conversions when applied to calculations from the light-unit measuring system.

Still another object of the present invention is a ruler made of gradations based on the new JAK-measuring system.

Other objects and advantages of the present invention will become apparent as a description thereof proceeds.

### BRIEF DESCRIPTION OF THE FIGURES

Reference is now made to the drawings of the invention wherein:

FIG. 1 is a perspective view of a prior art ruler having both the conventional U.S. linear and metric gradations;

FIG. 2 provides one perspective view of the JAK-ruler having both JAK-linear and JAK-metric gradations;

FIG. 3 provides a table depicting the ratios between the JAK-linear and JAK-metric systems; and

FIG. 4 provides a table depicting the ratios between the JAK-linear and JAK-metric systems vs. the U.S. linear and the SI linear-metric systems.

### DETAILED DESCRIPTION OF THE INVENTION

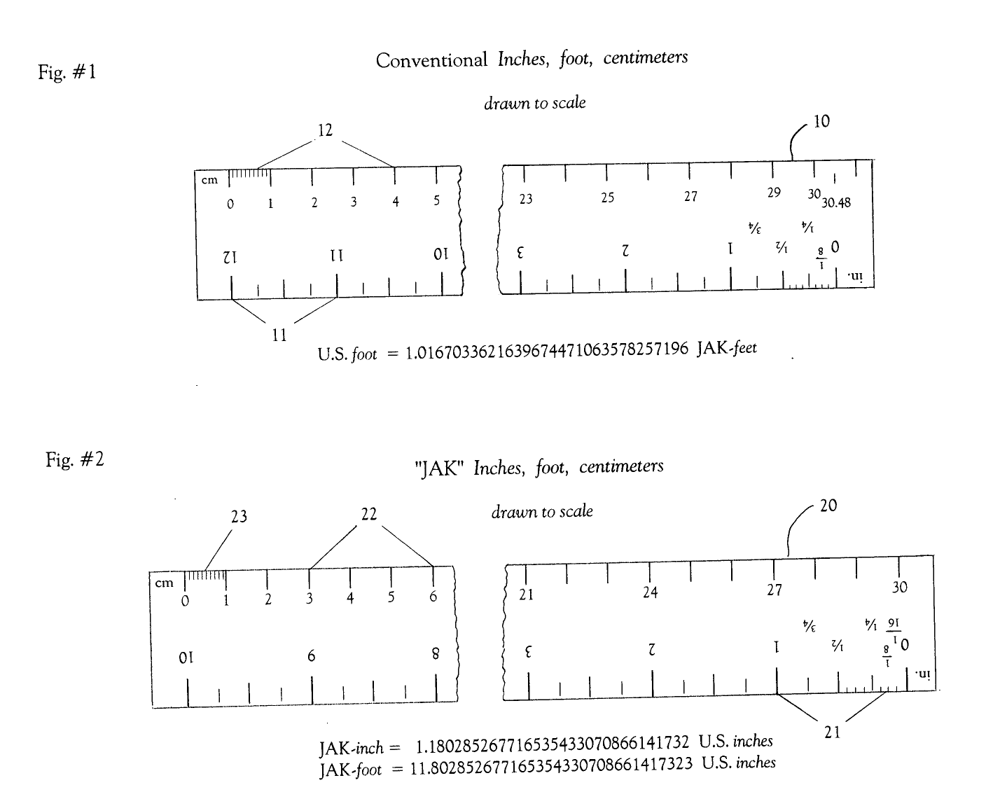

For comparison purposes, FIG. 1 displays a standard ruler 10 with conventional gradations in U.S. linear 11 and SI metric 12.

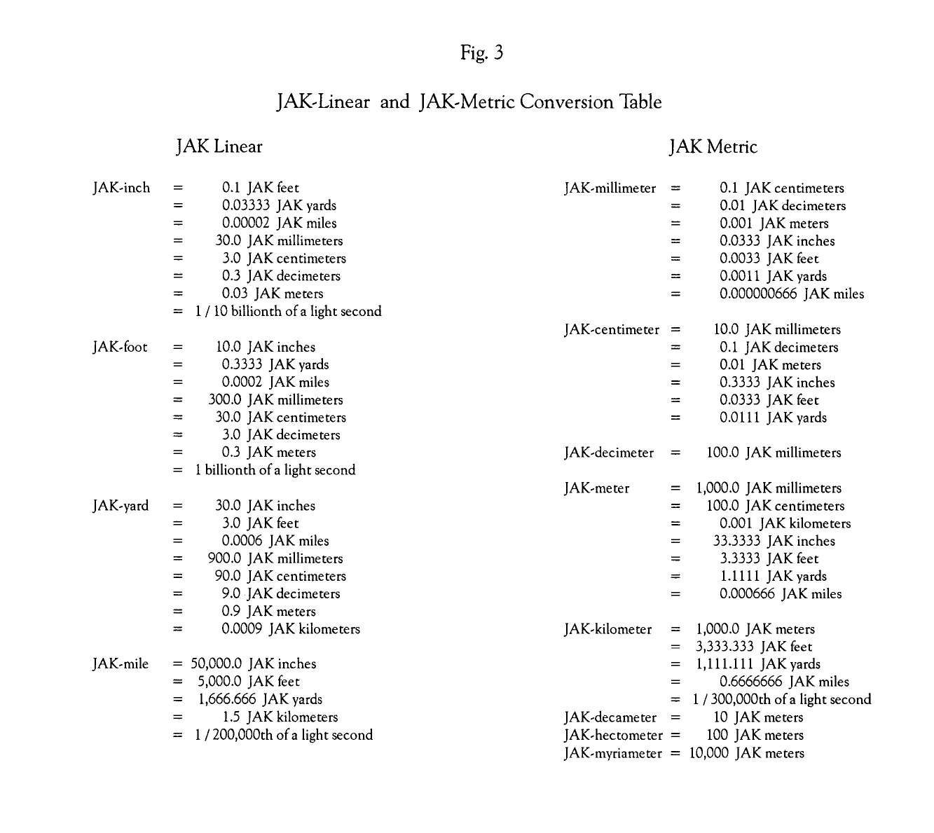

FIG. 2 displays a JAK-ruler 20 with two scales that clearly show the gradations of the JAK-linear system 21 and the JAK-metric system 22 with the smallest gradation being the JAK-millimeter 23 of the present invention. It shows that three JAK-centimeters 22 equal one JAK-inch, and thirty JAK-centimeters equal one JAK-foot. It also shows that there are ten JAK-inches to the JAK foot and ten JAK-millimeters to the JAK-centimeter.

The present invention is a new measuring system that provides a means for linear measure with a first set of gradations being referred to as the JAK-linear system with each gradation being based on the decimal system with a radix of 10 (base 10) where 10 JAK-inches make a JAK-foot, 30 JAK-inches make a JAK-yard, and 5,000 JAK-feet make a JAK-mile as is displayed on the scaled ruler in FIG. 2 and in the table in FIG. 3. The JAK-inch can be divided into smaller increments of ½″, ⅜″, ¼″, ⅛″, 1/16″, 1/32″, 1/64″, 1/128″, or ⅓″, ⅙″, 1/12″, 1/24″, 1/48″, 1/96″, or ⅕″, 1/10″, 1/20″, 1/40″, etc., as needed by anyone who uses or manufactures this invention.

The present invention also includes a set of metric gradations. The metric gradations are based on the ratio of ⅔ JAK-mile per JAK-kilometer as exhibited in the table displayed in FIG. 3. In the present invention, the JAK-mile equals 1.5 JAK-kilometers. As with the SI metric system, the JAK-meter is subdivided into smaller units: 1,000 JAK-millimeters=one JAK-meter, 100 JAK-centimeters=one JAK-meter, and 10 JAK-decimeters=one JAK-meter. On a larger scale, there are 10 JAK-meters per JAK-decameter, 100 JAK-meters per JAK-hectometer, 1,000 JAK-meters equal one JAK-kilometer, and 10,000 JAK-meters equal one JAK-myriameter. A full range of the present invention's incremented measuring gradients and their ratios is exhibited in the table displayed in FIG. 3.

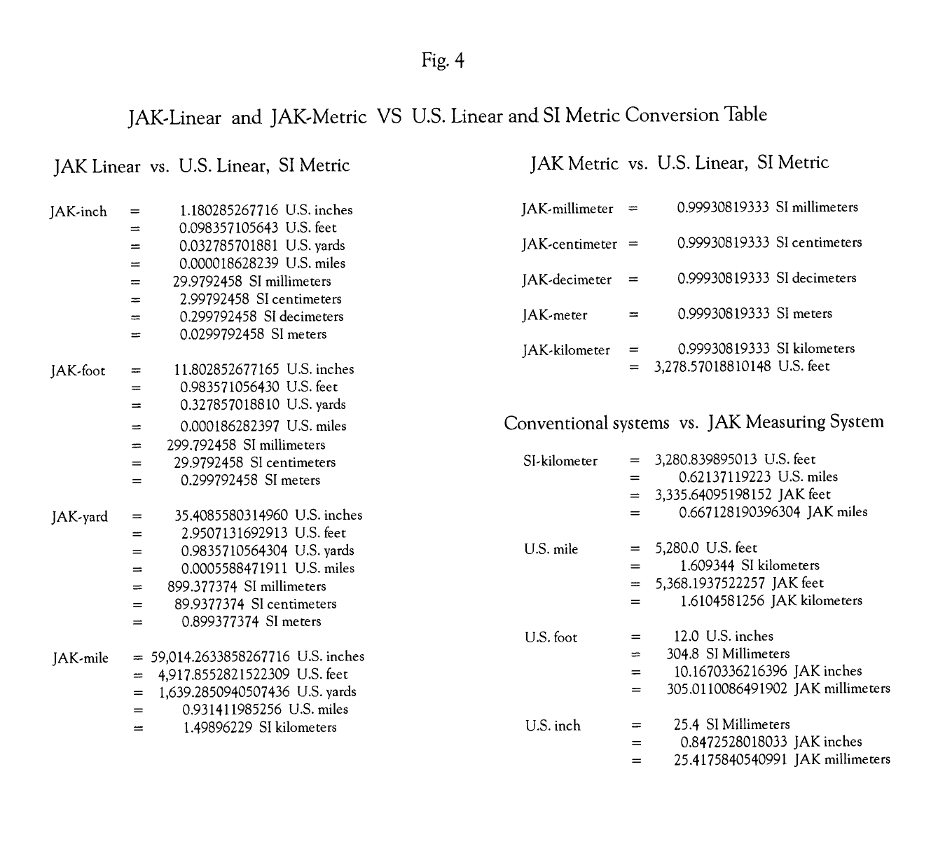

A full range of the present invention's incremented measuring gradients and their comparison ratios showing the differences between tne present invention and the conventional U.S. linear and SI metric systems is exhibited in the table displayed in FIG. 4. Noteworthy comparisons between the present invention and the conventional U.S. linear and SI metric systems are as follows:

(a) There are 1.1802852677165354330708661417323 U.S. inches per JAK inch, 0.9835710564304461942257217847769 U.S. feet (11.802852677165354330708661417323 U.S. inches) per JAK-foot, 0.9835710564304461942257217847769 U.S. yards per JAK-yard, and 0.93141198525610435059253956891752 U.S. miles per JAK-mile. The JAK-mile is equal to 4,917.8552821522309711286089238845 U.S. feet, and 1.49896229 SI kilometers;

(b) The JAK-millimeter, JAK-centimeter, JAK-decimeter, JAK-meter, JAK-decameter, JAK-hectometer, JAK-kilometer, and the JAK-myriameter are all equal to 99.9308193333333% of their respective SI counterparts;

(c) The JAK-kilometer is equal to 3,278.5701881014873140857392825896 U.S. feet;

(d) The SI-kilometer is equal to 3,280.8398950131233595800524934383 U.S. feet, and 3,335.6409519815204957557671447492 JAK-feet; and

(e) The U.S. mile is equal to 5,368.1937522257481207215693197992 JAK-feet, and 1.6104581256677244362164707959398 JAK-kilometers.

It should be noted that the second is officially defined as 9,192,631,770 periods of the radiation (waves) corresponding to the transition between the two hyperfine levels of cesium-133; however, the second averages 1/86,400th of a mean solar day. The earth's tropical year equals 31,556,925.9747 seconds (365.24219878125 solar days).

Since the present invention aligns with the light-second and not the light-year, the advantages benefit both small and large scale operations. Currently, the light-second is defined as 186,282.3970512208701185079137835 U.S. miles (299,792.458 SI km) and the light-year is 5,878,499,814,135.050562589477451682 U.S. miles (9,460,528,404,879.3588126 SI km). Using the present invention, these same distances are expressed as 200,000 JAK-miles (300,000 JAK-km) per one light-second, and the light-year is expressed as 6,311,385,194,940 JAK-miles (9,467,077,792,410 JAK-km). The advantage derived from the present invention when dealing with great distances is not having to deal with fractions.

It should be noted that although the new matter introduced by the present invention makes conversions between all three conventional measuring systems (U.S. linear system, the SI metric linear system, and the light-unit measuring system) user friendly, it only changes (or replaces) the U.S. linear system and the SI metric linear system; in no way does it change the light-unit measuring system. The light-unit measuring system remains a “distance per time” measuring system; it calculates distance the same way regardless of with which system it is being used.

### Operation—Preferred Embodiment

In practice, any known means can be employed using the gradations of the present system whether they be tape measures, straight edges, carpenter squares, protractors, folding rulers, and the like. Electronic devices can be programmed to sense the new gradations, and display the same. The present invention's measuring configurations can also be incorporated into any electronic device, computer, etc., and used for the purpose of measuring and determining sizes, converting sizes of conventional known systems, and for the measurement of distances to be depicted in electronic displays, printouts, messages, etc., for the business world, scientific community, or for any of the many various daily uses that will meet the needs of society.

Since the present invention's measuring systems align with the decimal system, each other, and with the speed-of-light measuring system, conversions between all three are user friendly making calculations easier for everyone from students in school to our top leading scientists.

I claim:

1. A measuring system having a means for linear measurement with a first new set of linear gradations spaced along a length thereof, each gradation being based on the decimal system, wherein said decimal system is based on the radix 10, base 10, number system and said first set of new gradations is representing a JAK-linear system wherein a JAK-linear gradation from said new set is a JAK-inch wherein 10 JAK-inches make up a JAK-foot wherein said JAK-foot is equal to 11.802852677165354330708661417323 U.S. inches.

2. The system of claim 1 wherein said JAK-inch is subdivided into ½ inch, ⅜ inch, ¼ inch, ⅛ inch, 1/16 inch, 1/32 inch, 1/64 inch, 1/128 inch and so forth.

3. The system of claim 1 wherein said JAK-inch is subdivided into ⅓ inch, ⅙ inch, 1/12 inch, 1/24 inch, 1/48 inch, 1/96 inch and so forth.

4. The system of claim 1 wherein said JAK-inch is subdivided into ⅕ inch, 1/10 inch, 1/20 inch, 1/40 inch, 1/80 inch and so forth.

5. The system of claim 1 further including one JAK-inch equals three JAK-centimeters.

6. The system of claim 1 further including 3 JAK-feet equal one JAK-yard and 5,000 JAK-feet equal one JAK-mile.

7. The system of claim 1 comprising a ruler having the first set of JAK-linear gradations thereon.

8. The system of claim 1 wherein said means for linear measurement is selected from the group consisting of a tape measure, a straightedge, and a foldable measuring device, or are incorporated into electronic devices and their software.

9. A measuring system having a means for linear measurement with a new set of metric gradations representing a JAK-metric system wherein a JAK-metric gradation from said new set includes one of a JAK-meter wherein said JAK-meter is equal to 0.99930819333333 SI meters, a JAK-millimeter wherein one thousand JAK-millimeters equal one JAK-meter, a JAK-centimeter wherein one hundred JAK-centimeters equal one JAK-meter, a JAK-decimeter wherein ten JAK-decimeters equal one JAK-meter.

10. The system of claim 9 further including ten JAK-meters equal one JAK-decameter.

11. The system of claim 9 further including one hundred JAK-meters equal one JAK-hectometer.

12. The system of claim 9 further including one thousand JAK-meters equal one JAK-kilometer.

13. The system of claim 9 further including 10,000 JAK-meters equal one JAK-myriameter.

14. The system of claim 9 comprising a ruler having JAK-inches on one edge, and one of said JAK-millimeters and said JAK-centimeters on another edge.

15. The system of claim 9 wherein said means for linear measurement is selected from the group consisting of a tape measure, a straightedge, and a foldable measuring device, or are incorporated into electronic devices and their software.

16. A method of measuring large distances between two points that are readily converted to JAK-kilometers, JAK-miles, JAK-feet, and JAK-inches from the speed-of-light measuring system comprising the steps of:
a) reading a first distance measurement in terms of light-years,
b) converting said light-years into light-seconds by multiplying the total number of seconds in a year times the total number of said light-years,
c) multiplying said light-seconds times 200,000 to convert measurement into said JAK-miles,
d) multiplying said JAK-miles times 5,000 to convert measurement into said JAK-feet.

17. A method according to claim 16 wherein said light-seconds are converted directly into said JAK-feet by multiplying said light-seconds times 1,000,000,000.

18. A method according to claim 16 wherein said light-seconds are converted into JAK-kilometers by multiplying said light-seconds times 300,000.

19. A method according to claim 16 further including said JAK-miles are converted into JAK-kilometers by multiplying said JAK-miles times 1.5.

20. A method according to claim 16 further including JAK-kilometers are converted into said JAK-miles by dividing said JAK-kilometers by 1.5.
